(19) United States
(12) Patent Application Publication
(10) Pub. No.: US 2005/0230371 A1
(43) Pub. Date: Oct. 20, 2005

(54) Laser roll joining method for dissimilar metals and laser roll joining apparatus

(75) Inventors: Muneharu Kutsuna, Anjo-shi (JP); Akihiko Tsuboi, Nagoya-shi (JP); Manoj Rathod, Nagoya-shi (JP)

Correspondence Address: OLIFF & BERRIDGE, PLC, P.O. BOX 19928, ALEXANDRIA, VA, 22320, US

(73) Assignees: FINE PROCESS COMPANY, LTD., Nagoya-shi (JP); Muneharu KUTSUNA, Anjo-shi (JP)

(21) Appl. No.: 11/082,886

(22) Filed: Mar. 18, 2005

Related U.S. Application Data
(63) Continuation of application No. PCT/JP03/12299, filed on Sep. 25, 2003.

(30) Foreign Application Priority Data
Sep. 26, 2002 (JP) 2002-280191

(51) Int. Cl. B23K 26/00

(52) U.S. Cl. 219/121.85; 219/121.64

(57) ABSTRACT

An object is to provide a laser roll joining process for dissimilar metals capable of improving the joining strength of a joint by increasing the amount of generation of ductile intermetallic compound and a laser roll joining equipment. A laser roll joining process for dissimilar metals for joining a first metal sheet 3 and a second metal sheet 4 of different materials held in non-contact state by after only the first metal sheet 3 is heated by laser irradiation, pressing a heated portion of the first metal sheet 3 against the second metal sheet 4 with a pressure welding roller 15 so that they are brought into a firm contact with each other and subjected to plastic deformation, wherein a joining portion between the first metal sheet 3 and the second metal sheet 4 is cooled.

### CROSS-REFERENCE TO RELATED APPLICATIONS

This application is a continuation application based upon and claims the benefit of the prior PCT International Patent Application No. PCT/JP2003/012299 filed on Sep. 25, 2003, the entire contents of which are incorporated herein by reference.

### BACKGROUND OF THE INVENTION

1. Field of the Invention

The present invention relates to a laser roll joining process for joining of sheets of dissimilar metals for example, steel and aluminum alloy sheets, used for manufacturing a structural parts in transportation industries such as automobiles, aircrafts, vehicles and ships.

2. Description of Related Art

In transportation industries of automobiles, aircrafts, vehicles, and ships, reduction in vehicle body weight has progressed as a means for relaxing the problem on earth green house effect. Therefore, light weight hybrid structural parts produced by joining dissimilar metal sheets like light weight aluminum alloy or magnesium alloy and high strength carbon steel or stainless steel have attracted public attention. How cheap these parts can be manufactured by a highly reliable joining process is a current important problem. However, joining dissimilar metals like aluminum alloy and carbon steel has been thought extremely difficult to maintain its strength.

Conventionally, processes used for joining of aluminum alloy and steel for different applications include roll pressure welding, explosion welding, diffusion bonding and resistance spot welding. TAIZAN et al tried joining of the sheets by resistance spot welding using aluminum clad steel as an insert material in 1996 (non-patent document 1).

By measuring the mechanical properties of different intermetallic compounds of iron(Fe) and Aluminium(Al), it was found that the aluminum rich compounds such as FeAl₃ and Fe₂Al₅ were brittle, while iron rich compounds such as FeAl and Fe₃Al were relatively ductile (non-patent document 2). Thus, a major problem in joining of iron-aluminum by conventional means was existence of brittle intermetallic compound at the joint interface, which reduces the tensile strength and induces brittleness.

It has been pointed out that brittleness of the joint is induced by Kirkendall porosity due to interdiffusion rather than generation of thin intermetallic compound layer and if the diameter of intermetallic compound particles at the joint interface is 4 μm or less, a high fracture toughness value of the joint is achieved. (non-patent document 3).

On the other hand, recently, use of laser for joining of iron with aluminum has been reported by Sepold et al in Germany (non-patent document 4). When material is irradiated by a laser beam, it is subjected to fast heating and fast cooling thermal cycle which is a non-equilibrium condition. Therefore formation of brittle intermetallic compounds is suppressed as the material remains at high temperature for very short period.

Roll pressure welding is used mainly for manufacturing aluminum clad steel sheets. Bond is developed when plastic deformation of aluminum at the interface forms new surface protruding in the scratches present on the steel surface. It was found that there is an optimum relative slide between steel and aluminium surfaces at the interface for getting high bond strength. Relative slide is expressed in terms of reduction of steel and aluminum. Vacuum roll bonding with low reduction in thickness have been conducted by MUKAE, NISHIO and others (no-patent document 5). It was found that shear strength of mild steel and 5083 aluminum joints remained constant at about 60 MPa when the total reduction was above 5%, but it decreased after the post heat treatment as the interface compound thickness increased.

Although, according to the conventional laser roll joining process for metal sheets of dissimilar materials, such an idea that an excellent result might be obtained if heating with laser and applying pressure with a pressure welding roller were executed at the same time was proposed, joining ensuring a sufficient strength could not be attained in actual experiments. That is, nobody could obtain a necessary condition. For example, when sheets of steel and aluminum alloy are joined, it is known that the joint becomes brittle due to the formation of aluminum rich intermetallic compounds is at the interface reducing the joint strength. However, the means of avoiding or suppressing the formation of aluminium rich intermetallic compounds is not understood. Naturally, unless the steel and the aluminum alloy sheets are heated up to high temperatures, the intermetallic compound does not become rich in aluminum. However, the joining strength of the both itself drops and therefore, appropriate joining cannot be performed.

Hence, this inventor has proposed a process for joining dissimilar metals such as SPCC steel and aluminum alloy sheets, called as laser roll pressure welding in which the materials are irradiated with a laser beam and simultaneously pressure is applied with a roll. (non-patent documents 6, 7). According to this process, the SPCC steel and the aluminum alloy sheets are held together with some space (gap) and then the SPCC steel sheet is heated by irradiating with a laser beam quickly, the heated part of the SPCC steel sheet is pressed against the aluminum alloy sheet with the pressure roller and the sheets are joined by subjecting to plastic deformation. Thus, although the side of the joining face of the SPCC steel sheet is heated up to the eutectoid temperature (about 1170° C.) quickly, due to the gap between the SPCC steel and the aluminum alloy sheets, the aluminum alloy sheet is not heated directly by laser. By pressing the SPCC steel sheet against the aluminum alloy sheet with the pressure roller they are brought into a firm contact with each other, the surface of the aluminum alloy sheet is melted rapidly while the joint interface is cooled quickly due to heat diffusion (conduction) into the interior of the aluminum alloy sheet and as a consequence, formation of brittle intermetallic compounds FeAl₃ and Fe₂Al₅, is suppressed.

FIG. 15 shows the relation between the ratio of thickness of intermetallic compound layer formed and the feed rate (joining speed/travel speed) as a result of laser roll pressure welding of dissimilar metals. FIG. 16 is a diagram showing the relation between the feed rate (joining speed/travel speed) and shear strength of the joints. The shear strength test was conducted on the laser roll joints with shear surface area of 24 mm² (8 mm width×3 mm overlapped length).

Following points are noted from FIG. 15. As the feed rate (joining speed/travel speed) is increased, the average interface layer thickness decreased and at the same time, the thickness of brittle compounds (FeAl₃+Fe₂Al₅) decreased. More specifically, although the interface thickness was 12 μm at 1.2 m/min, it decreased to 2 μm at the maximum speed of 2.0 m/min while the brittle compound layer decreased from 77% to 49%. Thus, it was found that as the feed rate (joining speed/travel speed) increased, the ratio of ductile compound increased, suppressing the brittle compound layer.

On the other hand, as shown in FIG. 16, if the feed rate (joining speed/travel speed) was increased, the shear strength increased until it reached a specific speed, it decreased after it showing a maximum value. The maximum shear strength was 55.8 MPa which was obtained when thickness of the interface layer was 5 μm and at this time, the feed rate (joining speed/travel speed) was 1.6 m/min, roll pressure was 150 MPa and the laser power was 1.5 kW. If this is compared with a result of FIG. 15, although the ratio of brittle compound decreased for the speeds between 1.8 and 2.0 m/min, the input heat energy was insufficient giving incomplete joint and therefore the shear strength dropped.

(Non-Patent Document 1)

M. Yasuyama, K. Ogawa, 1996. Spot welding of aluminium and steel sheet with insert of aluminium clad steel sheet—Part I. Journal of Japan Welding Society, Vol. 14, No. 2: 314-320
   (Non-Patent Document 2)
H. Okamoto: Phase Diagrams of Binary Iron Alloys, ASM International (1993), 12-28.
   (Non-Patent Document 3)
C E Albright: The Fracture toughness of steel-aluminium deformation weld, Welding Journal, Vol. 60, No. 11 (1981), 207s-214s.
   (Non-Patent Document 4)
G. Sepold, E. Schubert and I. Zerner: Laser beam joining of dissimilar materials, IIW, IV (734) (1999), 1-10.
   (Non-Patent Document 5)
S. Mukae, K. Nishio, M. Katoh, T. Inoue and N. Hatanaka, 1991. Development of vacuum roll bonding apparatus and production of clad metals-Part 1, Journal of Japan Welding Society, Vol. 9, No. 1, 17-23 (1991).
   (Non-Patent Document 6)
Muneharu Kutsuna and Rathod Manoj: Investigation of Roll-bonding condition for SPCC steel and A5052 aluminium alloy. Laser Roll Bonding of Dissimilar metals (Report 1), Reprints of the National Meeting of Japan Welding Society, Tokyo, No. 68, Mar. 19, 2001 P258-259.
   (Non-Patent Document 7)
Muneharu Kutsuna and Rathod Manoj: Relation between joint strength of Laser Roll Bonded SPCC steel and A5052 aluminium alloy and its interface structure. Laser Roll Bonding of Dissimilar metals (Report 2), Reprints of the National Meeting of Japan Welding Society, Morioka, No. 69, Sep. 10, 2001, p92-93.

According to the laser roll welding indicated in the above-mentioned non-patent documents 6, 7, joint interface layer with suppressed brittle intermetallic compound was formed and a joint with high shear strength was obtained. More specifically, the shear strength of the joint was 22.9 MPa-55.9 MPa, which corresponded to about 23%-57% the shear strength of aluminum alloy base material. However despite being capable of obtaining such an effect, laser roll welding has problems which should be solved, for example, it can not control quick heating and quick cooling process sufficiently and induces a remarkable surface oxidation.

For example, although as seen in the results of FIGS. 15 and 16 described previously, conventionally, whenever the feed rate (joining speed/travel speed) of dissimilar metal sheets is increased the ratio of ductile compound became higher than that of brittle compound, the shear strength reached a limit point halfway. Therefore, it is thought that while sufficient heat input is maintained by decreasing the feed rate (joining speed/travel speed) and if it is possible either to suppress heat input to the aluminum alloy sheet or rapid cooling is achieved, formation of FeAl₃, Fe₂Al₅, which are brittle intermetallic compounds can be suppressed regardless of the thickness of intermetallic compound formed; the joint strength can be increased by the compound in which the ratio of ductility is set higher than that of brittleness.

Therefore, present invention has been achieved in views of such problems. The object of present invention is to offer a laser roll joining process and laser roll joining equipment for joining dissimilar metals with ability to improve the joint strength by increasing the formation of ductile intermetallic compounds.

### BRIEF SUMMARY OF THE INVENTION

The laser roll joining equipment of the present invention to achieve the above-described object is characterized in joining first and second metal sheets of dissimilar metals. These sheets are clamped without contacting each other. The equipment comprises of a laser irradiation facility by which only first metal is heated by laser irradiation. It has a roller pressing facility for pressing the hot part of the first metal sheet—which is heated by the laser irradiation using the laser irradiating facility—against the second metal sheet with a pressure-welding roller so that they are brought into a firm contact with each other. The heated first metal sheet is pressed against the second metal sheet so as to induce plastic deformation and achieve a joint between the two metals.

Preferably, the cooling facility is provided to cool the second metal sheet from the non-contacting surface where the first and second metal sheets are pressurized by the pressure-welding roller.

Further, preferably, the cooling facility is provided to cool the pressure-welding roller and first metal sheet.

Therefore, the laser roll joining process for dissimilar metals of the present invention is implemented with the laser roll joining equipment, that is, first and second metal sheets of dissimilar metals are held without contacting each other; only the first metal sheet is heated by laser irradiation and after that, a heated portion of the first metal sheet is pressed against the second metal sheet with a pressure welding roller so that they are brought into a firm contact with each other and subjected to plastic deformation to join both the metal sheets together. In this process, the cooling at the joint between the first metal sheet and the second metal sheet is executed. At this time, to cool the joint, the second metal sheet is cooled from the side of the non-contact face or the pressure welding roller and the first metal sheet are cooled at a position in which the first metal sheet and the second metal sheet are pressurized by the pressure welding roller.

Thus, according to the present invention, heat entering the metal sheet diffuses internally effectively so that the temperature of the joint drops rapidly. Because the temperature range in which brittle intermetallic compounds are formed is passed in an extremely short time, the resistance to fracture can be improved by increasing the amount of ductile intermetallic compound.

The laser roll joining process for dissimilar metals of the present invention is implemented with the laser roll joining equipment, that is, first and second metal sheets of dissimilar metals are held without contacting each other; only the first metal sheet is heated by laser irradiation and after that, a heated portion of the first metal sheet is pressed against the second metal sheet with a pressure welding roller so that they are brought into a firm contact with each other and subjected to plastic deformation to join both the metal sheets together. Further, the first and second metal sheets are pressed against each other while entering below the roller; changing their condition from widely separated faying surfaces to the overlapped ones. The characteristic of this equipment is by irradiating the first metal sheet, the laser irradiating facility helps in laser irradiating the interface of the joint.

It is desired that the laser irradiating facility makes such an incident angle of the laser beam on the surface of first metal sheet which is almost equal to the Brewster angle.

Therefore, the laser roll joining process of the present invention for joining dissimilar metals is implemented with the laser roll joining equipment, that is, the first and second metal sheets are fed so that they are converted from the condition of widely separated joint surfaces to the overlapped joint. Only the first metal sheet is heated by laser irradiation for laser irradiation of the joint interface. After that, the first metal sheet is pressed against the second metal sheet with the pressure welding roller so that they are brought into a firm contact with each other and by subjecting to plastic deformation, both the metal sheets are joined together. While joining, the surface of first metal sheet is irradiated with laser beam so that the incident angle is set close to the Brewster angle.

Because the present invention requires only a minimum heat input for heating the joint interface to a predetermined temperature, the cooling effect after that is high. Because the reflection is kept low and most energy is absorbed by the first metal sheet as the incident angle of the laser beam is close to the Brewster angle, effective heating can be carried out and the joint can be obtained by laser power in which energy consumption is reduced.

The laser roll joining process for dissimilar metals of the present invention is implemented with the laser roll joining equipment, that is, first and second metal sheets of dissimilar metals are held without contacting each other; only the first metal sheet is heated from the side of the non-contact surface by pulse-like laser beam irradiation and after that, a heated portion of the first metal sheet is pressed against the second metal sheet with a pressure welding roller so that they are brought into a firm contact with each other and subjected to plastic deformation to join both the metal sheets together. Further, the laser irradiating facility is connected to a control to produce a laser beam in the pulsed mode leading to form irradiation of overlapping spots in the direction of the joint line on the non-contacting surface of the first metal sheet.

Preferably, the control is provided to control the drive of the laser irradiating facility so that the heating spots generated on the joint surface of the first metal sheet side are continuously overlapping.

Further, preferably, the control synchronizes the pulse irradiation with the feed rate (joining speed/travel speed) of both of first and second metal sheets so that the heating spots are continuous.

Therefore, the laser roll joining process for dissimilar metals of the present invention is implemented with the laser roll joining equipment, that is, first and second metal sheets of dissimilar metals are held without contacting each other. Only the first metal sheet is heated from the side of the non-contact surface by pulse-like laser beam irradiation leading to form irradiation of overlapping spots in the direction of the joint line and after that, a heated portion of the first metal sheet is pressed against the second metal sheet with a pressure welding roller so that they are brought into a firm contact with each other and subjected to plastic deformation to join both the metal sheets together. The laser irradiation is carried out so that the heating spots generated on the side of the joining face of the first metal sheet are continuous. Further, the pulse irradiation may be carried out synchronous with the feed rate (joining speed/travel speed) of both of first and second metal sheets so that the heating spots are continuous.

Because the present invention employs the pulse laser to reduce heat input by avoiding continuous irradiation of the laser beam, the cooling effect after heating can be intensified. Because the shear strength of the joint is increased by forming the continuous heating spots which are preferred to the continuous irradiation.

The laser roll joining equipment for dissimilar metals of the present invention should have the means to prevent oxidation of both the metal sheets to be joined under high temperatures. Inactive gas is blown against the joining portions of both the sheets and the side of material having a strong oxide film like aluminum is coated with flux. Such an oxidation preventing means is preferred to coat with flux by spraying, screen printing or with dispenser.

Further, the laser roll joining equipment for dissimilar metals of the present invention is preferred to be so constructed that the joining is carried out with steel sheet as the first metal sheet and aluminum sheet or aluminum alloy sheet as the second metal sheet.

### BRIEF DESCRIPTION OF DRAWINGS

FIG. 1 is a schematic structure diagram showing joining execution major portions of a laser roll joining equipment for executing laser roll joining process of dissimilar metals;

FIG. 2 is a diagram showing disposition of SPCC steel sheet and aluminum alloy sheet as viewing FIG. 1 in the X direction indicated with an arrow;

FIG. 3 is a diagram showing conceptually the section of a heated portion of the SPCC steel sheet directly irradiated with laser beam;

FIG. 4 is a diagram showing the interdiffusion coefficient based on heating temperature of steel and aluminum alloy with a graph;

FIG. 5 is a drawing showing a block diagram of a feature portion of an embodiment of a laser roll joining equipment 1;

FIGS. 6A and 6B are diagrams showing pulse irradiation state for continuing heating spot;

FIGS. 7A to 7C are diagrams showing pulse conditions of pulse laser power;

FIGS. 8A to 8C are diagrams showing pulse conditions of pulse laser power;

FIG. 9 is a diagram showing a condition in which a table is used as heat sink, as the structure of cooling means;

FIG. 10 is a diagram showing a condition in which a plurality of supporting rollers are immersed in a container containing refrigerant as the structure of cooling means;

FIG. 11 is a diagram showing a cooling method for cooling the side of the SPCC steel sheet as well as the aluminum alloy steel side;

FIG. 12 is a diagram showing an irradiation method for the joining face in a laser roll joining equipment;

FIG. 13 is a diagram showing an irradiation method for the joining face in a laser roll joining equipment;

FIG. 14 is a diagram showing oxidation preventing means of the laser roll joining equipment;

FIG. 15 is a diagram showing the thickness of the interface layer, and the ratio of brittle and ductile compounds;

FIG. 16 is a diagram showing the relation among feed rate, shear strength and interface layer thickness; and

FIG. 17 is a metallic state diagram of Fe—Al.

### DETAILED DESCRIPTION OF THE PREFERRED EMBODIMENTS

Next, an embodiment of a laser roll joining process and a laser roll joining equipment for dissimilar metals of the present invention will be described with reference to the drawings. The laser roll joining process of this embodiment and the laser roll joining equipment for executing this are constructed based on the laser roll pressure welding proposed by this inventor described in the non-patent documents 6, 7. The different type metal sheets to be jointed together are carbon steel sheet and aluminum alloy sheet and more specifically, SPCC steel (cold rolled material of low carbon steel), which is a structural material used for automobile and A5052-0 alloy (2.5 wt % Mg), which is ductile aluminum alloy. The thickness of the SPCC steel sheet 3 is 0.5 mm and the thickness of the aluminum alloy sheet 4 is 1 mm.

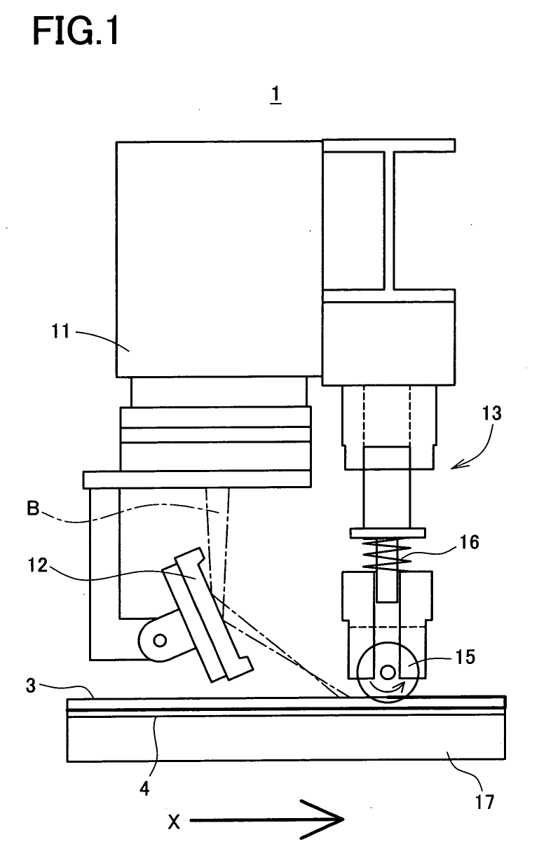

FIG. 1 is a schematic structure diagram showing the joining execution major portions of the laser roll joining equipment for executing the laser roll joining process for different type metals. In the joining execution major portion of this laser roll joining equipment 1, a 2.4 kW CO₂ laser (hereinafter referred to just “laser”) 11, a plane reflection mirror 12 and a roller jig 13 are combined. A SPCC steel sheet 3 and an aluminum alloy sheet 4, which are of different type metals, are loaded on a table 17 and fed from the left to the right indicated with an arrow X. In the roller jig 13, the SPCC steel sheet 3 located above is pressurized by a pressure welding roller 15 with a pressure applying spring 16 in which a roll pressure is measured and set up preliminarily. The roll pressure is computed from the length of the pressure applying spring 16 and by changing a difference in elongation/contraction of the pressure applying spring 16 to 4.5 mm-5.5 mm, the roll pressure is set to 150 MPa-202 MPa.

Laser beam B having Gaussian distribution outputted from the laser 11 is focused through a ZnSe lens (not shown). Then, a plane reflection mirror 12 is disposed at an output destination of the laser beam B and the laser beam B reflected by this plane reflection mirror 12 is irradiated to near the pressure welding roller 15. Because the SPCC steel sheet 3 and the aluminum alloy sheet 4 are fed in the X direction indicated by the arrow and pressurized by the pressure welding roller 15 so that a joining line (joining portion) is formed on both the sheets, the laser beam reflected by the plane reflection mirror 12 is so set that it is irradiated to just before the pressure welding roller 15 with respect to the SPCC steel sheet 3 fed in the X direction indicated by the arrow. Because according to this embodiment, wide laser heating is necessary so as to have a joining line about 3 mm wide, defocusing distance of 25 mm is employed. The laser beam B to be irradiated to the SPCC steel sheet 3 is of a shape approximate to an ellipse whose long side is the feeding direction (X direction indicated with the arrow) and its long side is about 3.5 mm while its short side is about 2.5 mm.

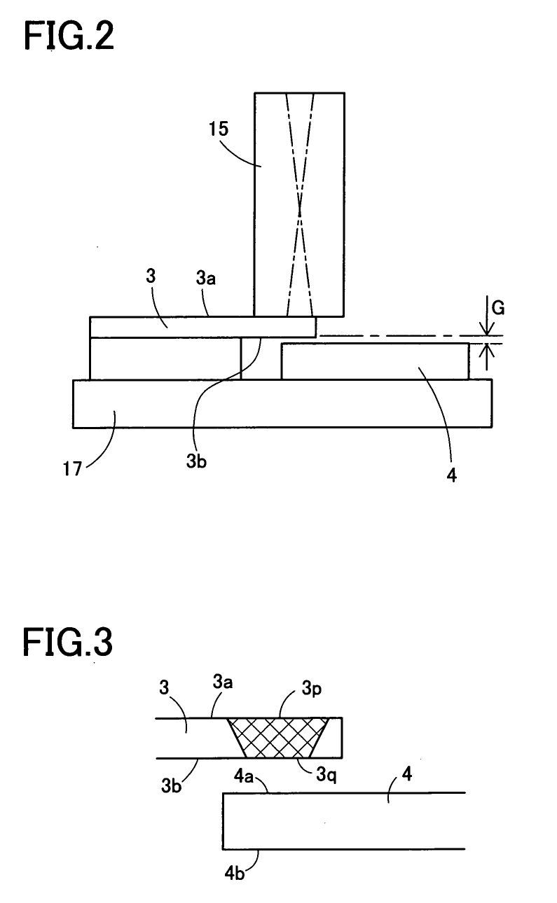

FIG. 2 is a diagram showing disposition of SPCC steel sheet and aluminum alloy sheet as viewing FIG. 1 in the X direction indicated with an arrow. A portion in which the SPCC steel sheet 3 and the aluminum alloy sheet 4 overlap each other as shown in the Figure is provided with a gap G of 0.2 mm to prevent both the sheets from making contact until they are pressurized by the pressure welding roller 15. For the heating laser B for joining the SPCC steel sheet and the aluminum alloy sheet 4, laser heat input is computed according to a heat distribution model and further, the temperature of the surface is determined by measuring actually. FIG. 3 is a diagram showing conceptually the section of a heated portion of the SPCC steel sheet directly irradiated with laser beam B. Although an irradiation spot 3p of the aforementioned size appears on the irradiation face 3a of the SPCC steel sheet 3 as shown in FIG. 3, a heating spot 3q which appears on the joining face 3b of the SPCC steel sheet 3 for heating the aluminum alloy sheet 4 is smaller than that.

In the laser roll joining equipment 1, joining of the SPCC steel sheet 3 and the aluminum alloy sheet 4 is carried out according to a following method. That is, the SPCC steel sheet 3 and the aluminum alloy sheet 4 are fed in the X direction indicated with the arrow and the SPCC steel sheet 3 heated by laser irradiation is pressed against the aluminum alloy sheet 4 by roll pressure of the pressure welding roller 15. At this time, the both sheets 3, 4 are held in the non-contact condition until the pressing is done and laser beam B is irradiated onto the irradiation face 3a of the SPCC steel sheet 3. Although, in the SPCC steel sheet 3 irradiated with laser beam B, the side of the joining face 3b on an opposite side is heated quickly to eutectoid temperature (about 1170° C.), heat is not transmitted directly to the aluminum alloy sheet 4 because of the gap G. After laser is irradiated, the SPCC steel sheet 3 is pressed against the aluminum alloy sheet 4 by the pressure welding roller 15 so as to carry out the joining by plastic deformation.

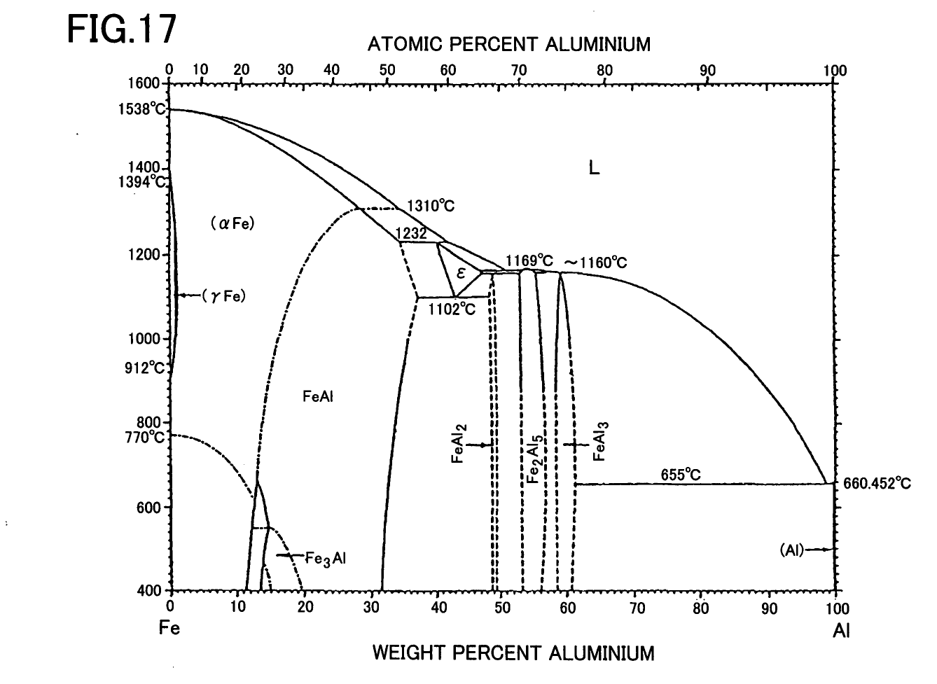

According to this joining process by the laser roll joining equipment 1, in the aluminum alloy sheet 4, a portion which the heating spot 3q of the SPCC steel sheet 3 is pressed against is melted quickly so that iron turns into wet condition due to that melting of the aluminum and as a consequence, iron atoms are separated and diffused into liquefied aluminum. The reason why the top surface of the SPCC steel sheet 3 is heated to 1200° C.-1400° C. is that the joining face of the rear face of the SPCC steel sheet 3 with respect to the aluminum alloy sheet 4 needs to be heated to temperatures over a predetermined one (about 1170° C. for Fe—Al series). Although the critical temperature differs depending on combination of metals to be joined together, it may be of any temperature as long as ductile intermetallic compound is produced or ductile eutectoid organization is obtained. In case of the SPCC steel sheet 3 and aluminum alloy sheet 4, as shown in FIG. 17, FeAl intermetallic compound which is relatively ductile under temperatures over about 1170° C. is generated.

In the aluminum alloy sheet 4 which the heated SPCC steel sheet is pressed against, heat diffusion is generated internally so that the joining portion is cooled rapidly. Such rapid internal diffusion of heat acts to intensify the joining strength although the thickness of brittle intermetallic compounds is small. Thus, according to the laser roll joining process at this stage, only the side of the SPCC steel sheet 3 disposed in the non-contact condition by providing with the gap G so as to accelerate the internal diffusion is heated and after that, by pressing against the aluminum alloy sheet 4, the amount of the input heat to the aluminum alloy sheet 4 is suppressed to protect the intermetallic compound from being rich in aluminum, which means brittle.

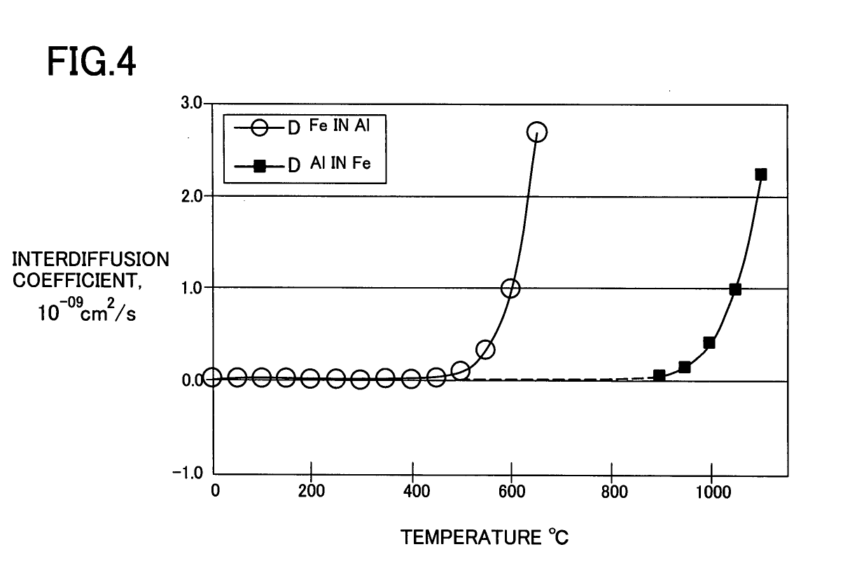

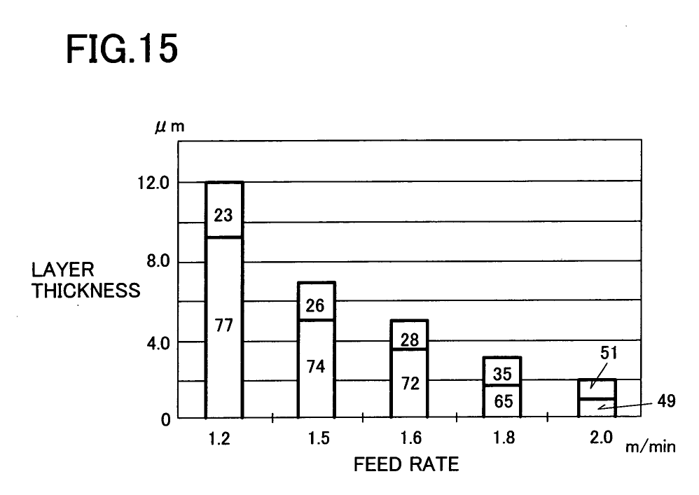

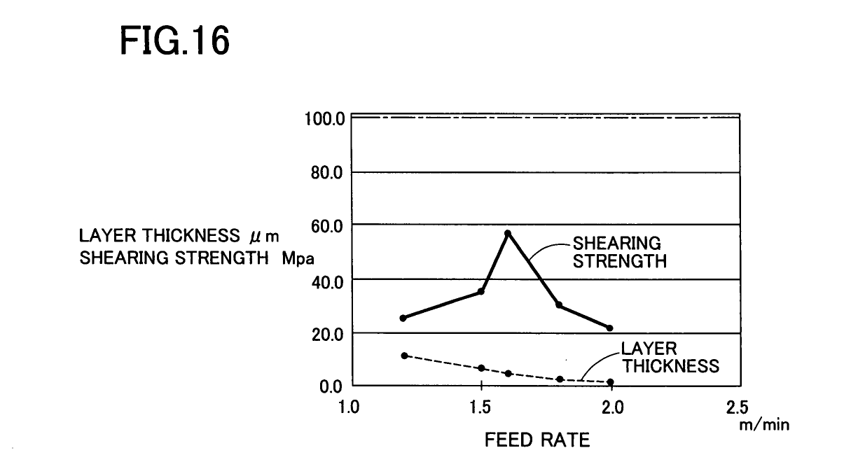

However, only if the gap G is provided between the SPCC steel sheet 3 and the aluminum alloy sheet 4, not only ductile intermetallic compound but also the brittle intermetallic compound as shown in FIG. 15 is generated on this joining interface. Generation of the brittle intermetallic compound is considered to be because the speed of the internal diffusion of heat input in the aluminum alloy sheet 4, particularly cooling speed on the joining interface is slow. FIG. 4 is a diagram showing the interdiffusion coefficient based on heating temperature of steel and aluminum alloy with a graph. Although the interdiffusion of iron and aluminum is very slow at temperatures 450° C. or less, if the temperature rises even slightly from 450° C., the diffusion of iron in aluminum becomes very slow and when it reaches 900° C., the diffusion of aluminum in iron becomes very fast.

Therefore, the intermetallic compound of FeAl, which is formed on the joining interface and is relatively ductile, is generated when the SPCC steel sheet 3 is pressed against the aluminum alloy sheet 4 and aluminum in iron is heated all at once up to a temperature in which the diffusion coefficient of aluminum in iron rises. However, although the aluminum alloy sheet 4 is cooled rapidly due to the internal diffusion of heat because it is not heated directly, when the temperature drops past 450° C.-600° C., in which the diffusion of iron occurs in aluminum, its passage time is about 1-2 seconds and thus, brittle metal aluminum rich compound is generated on the joining interface. That is, the cooling speed of the joining interface is an important factor which affects the joining break resistance in laser roll joining. The reason why the ratio of the brittle intermetallic compound is large as shown in FIG. 15 is considered to be because the amount of input heat is large as the feeding speed is slow and correspondingly, the cooling speed is slow.

Thus, the laser roll joining equipment 1 of this embodiment controls laser power, the size of irradiation spot of laser beam, feeding speed and the like and particularly, the cooling speed by cooling positively with a cooling means provided especially for the joining interface temperature at the cooling time to pass 450° C.-600° C., in which the diffusion coefficient of iron in aluminum is high. Further, because the temperature drop speed decreases if the amount of heat input to aluminum is small, the laser beam is irradiated in the form of pulse. Although this embodiment adopts both use of the cooling means and irradiation of laser pulse, it is permissible not to use the cooling means or use only the cooling means depending on the sheet thickness.

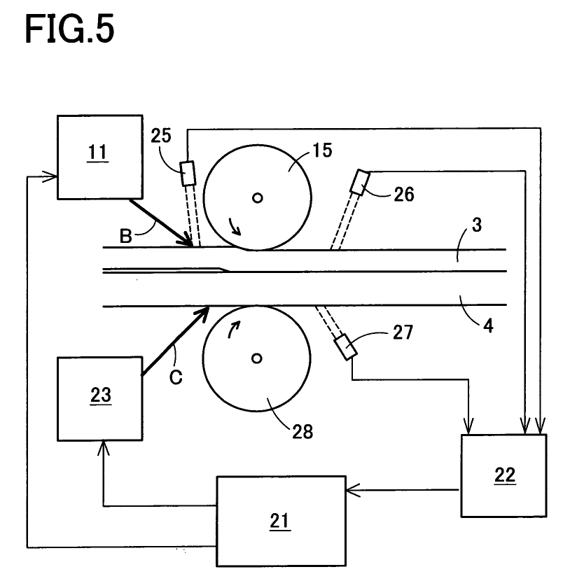

Thus, FIG. 5 shows a block diagram of a feature portion in the laser roll joining equipment 1 of this embodiment. The laser roll joining equipment 1 is so constructed that as shown in the joining execution major portions of FIG. 1, the SPCC steel sheet 3 and the aluminum alloy sheet 4 are held in the non-contact condition with the gap G (see FIG. 2) and fed vertically in parallel by a feeding means (not shown). Then, a laser 11 for heating the SPCC steel sheet 3 and a pressure welding roller 15 for pressing the SPCC steel sheet 3 heated by the laser 11 against the aluminum alloy sheet 4 are provided. Further, this laser roll joining equipment 1 includes a control unit 21 for controlling the operation of the entire unit, to which the laser 11 is connected, so that the timing of pulse irradiation to the SPCC steel sheet 3 is controlled. Then, a temperature monitor 22 and a cooling unit 23 are connected to this control unit 21, so that the cooling performance can be adjusted while monitoring the heating conditions of the SPCC steel sheet 3 and the aluminum alloy sheet 4.

As well as this cooling unit 23, the laser roll joining equipment 1 of this embodiment is provided with a first temperature sensor 25 for detecting a heating temperature at an irradiation position of the laser 11 on the SPCC steel sheet 3, a second temperature sensor 26 for detecting the temperature of the surface of the SPCC steel sheet 3 after it is pressed against the aluminum alloy sheet 4 by the pressure welding roller 15 and a third temperature detecting sensor 27 for detecting the temperature of the aluminum alloy sheet 4 after it is joined to the SPCC steel sheet 3. Then, the respective temperature sensors 25, 26, 27 are connected to the temperature monitor 22 so that the temperatures can be checked. Further, temperature data obtained from the respective temperature sensors 25, 26, 27 are carried to the control unit 21. The control unit 21 is so constructed to feed-back control the driving of the cooling unit 23 based on this temperature data.

The cooling unit 23 intends to reduce the temperature of the joining interface by spraying refrigerant to the rear face of the aluminum alloy sheet 4. As the refrigerant for cooling the joining interface, in case of gas, use of, for example, air or CO₂ gas and in case of liquid, use of water or liquid nitrogen can be considered. Further, in case of solid, dry ice can be used and it can be considered that the aluminum alloy sheet 4 is cooled by keeping it in a direct contact. Although the SPCC steel sheet 3 and the aluminum alloy sheet 4 are placed on the table 17 in case of the example shown in FIG. 1, there is provided a feeding means (not shown) for supporting and feeding them such that they are supported partially with a supporting roller 28 disposed just below the pressure welding roller 15 and fed, because it is necessary to secure a space for the cooling unit 23 to spray the refrigerant.

In the laser roll joining equipment 1 having such a structure, first, the SPCC steel sheet 3 and the aluminum alloy sheet 4 are fed in the X direction indicated with the arrow (feeding direction) from the left to the right in the Figure. At that time, the laser beam B having Gaussian distribution is outputted from the laser 11 and as shown in FIG. 1, reflected by the plane reflection mirror 12 and then, irradiated to the top face of the SPCC steel sheet 3 just before the pressure welding roller 15 located in the feeding direction. Because the SPCC steel sheet 3 and the aluminum alloy sheet 4 are fed linearly, a portion heated by laser irradiation is moved along the pressure welding roller 15 as it is so that the joining line is formed. The SPCC steel sheet 3 pressurized by the pressure welding roller 15 is pressed against the aluminum alloy sheet 4 supported by the supporting roller 28 from below. At this time, although the irradiation face 3a which is the top face of the SPCC steel sheet 3 is heated (see FIG. 3 for the following description), the joining face 3b on an opposite side has reached the eutectoid temperature (about 1170° C. in case of Fe—Al series). Thus, a joining face 4a of the pressed aluminum alloy sheet 4 is heated quickly and its temperature exceeds 650° C. which is a melting point of aluminum, so that only the surface is melted. Then, because the aluminum alloy sheet 32 whose joining face 4a is melted turns the joining face 3b of the SPCC steel sheet 3 into so-called wetty condition, iron molecules of the SPCC steel sheet 3 diffuse in the wetty joining face 3b, so that intermetallic compound is formed in the joining interface.

Heat entering into the aluminum alloy sheet 4 to generate the intermetallic compound heats the joining face 4a quickly and diffuses internally. According to this embodiment, by cooling the aluminum alloy sheet 4, the temperature of that joining portion can be dropped for an emergency. That is, liquid nitrogen C is injected from the cooling unit 23 to a heated portion supported by the supporting roller 28 and consequently, the aluminum alloy sheet 4 is cooled from the side of a cooling face 4b opposite to the joining face 4a. Because the temperature gradient between the joining face 4a and the cooling face 4b increases and particularly aluminum has a high heat conductivity, the internal diffusion of heat entering into the aluminum alloy sheet 4 is carried out effectively and as a consequence, the temperature of the joining portion drops rapidly.

Temperature drop is monitored by the second and third temperature sensors 26, 27 and measured temperatures as well as a temperature measured by the first temperature sensor 25 for monitoring a heating temperature of the SPCC steel sheet 3 are displayed on the temperature monitor 22. Then, the respective temperature data are sent from that temperature monitor 22 to the control unit 21 and a control signal is sent to the cooling unit 23 according to arithmetic operation of the control unit 21. In this way, adjustment of liquid nitrogen C injected from the cooling unit 23, that is, drive control of the cooling unit 23 is feed-back controlled based on values detected by the temperature sensors 26, 27. According to this embodiment, by adjusting the cooling capacity so as to raise cooling speed of the joining interface between the SPCC steel sheet 3 and the aluminum alloy sheet 4 by feed-back control, particularly a temperature range of 450° C.-600° C., which induces iron diffusion in aluminum as shown in FIG. 4, can be passed in an extremely short time (about 0.1 s).

To raise the cooling speed of the joining interface, if the amount of heat input to aluminum is set low from the beginning, the efficiency of the internal diffusion increases so that the temperature drop accelerates. For the reason, according to this embodiment, a control signal is sent to the laser 11 from the control unit 21 so as to control the laser beam B outputted from the laser 11. Particularly, according to this embodiment, the laser beam B is controlled to be irradiated in the form of pulses in order to avoid excessive heat input due to continuous irradiation. Although the pulse irradiation is adjusted appropriately depending on the feed rate of the SPCC steel sheet 3 and the aluminum alloy sheet 4, as one of the criteria, the heating spots 3q are adjusted to be continuous along the joining line because as shown with the heating sectional view of FIG. 3, the area of the heating spot 3q generated on the joining face is smaller than the area of the irradiation spot 3p. However, this criterion is based on the reason why the shear strength is increased by setting the heating spot 3q continuous (that is, the joined portion becomes continuous in the form of a line) and if a sufficient strength is obtained even if they are not continuous, it is not necessary to always set the heating spots continuous.

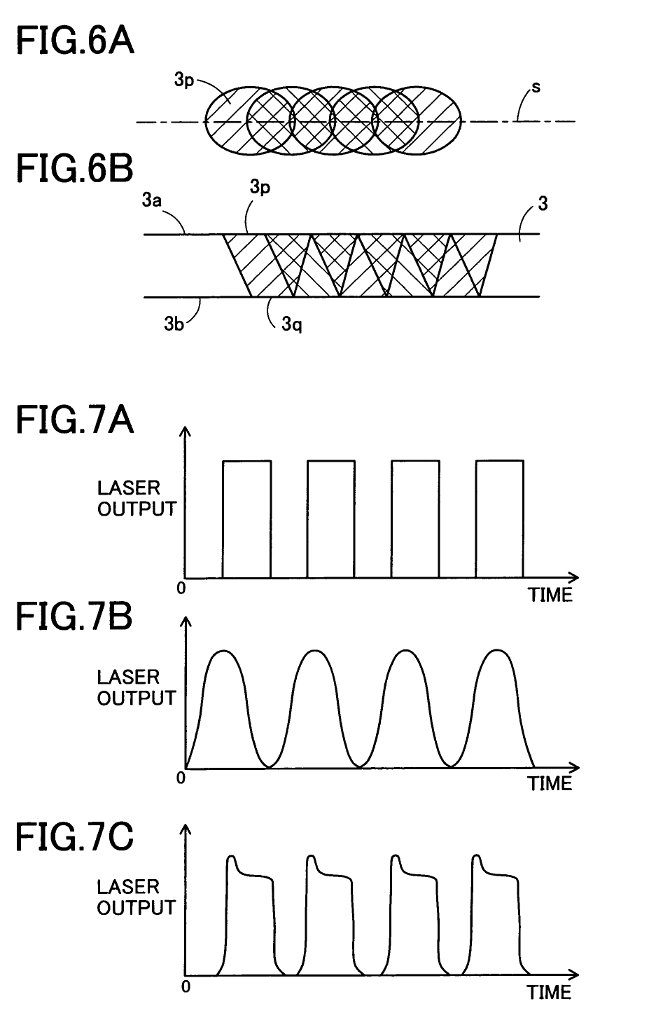

To keep the heating spots 3q continuous, as shown in FIG. 6A, the irradiation spots 3p are overlapped in the S direction of the joining line on the irradiation face 3a of the SPCC steel sheet 3 and as shown in FIG. 6B, irradiation needs to be made at such an interval that the heating spots 3q are continuous in the S direction of the joining line. FIGS. 7A to 7C are diagrams showing an example of laser beam B outputted from the laser 11. The way for controlling the pulse of the laser beam B outputted from the laser 11 may be of sine wave as well as rectangular waves as shown in FIGS. 7A and 7B. That is, drive control pulse for outputting the pulse laser is not restricted to any wave shape but as shown in FIG. 7C, it is permissible to make a peak at the head of a pulse by raising the output value of laser in order to increase the temperature of the front surface and improve and make better its absorption ratio.

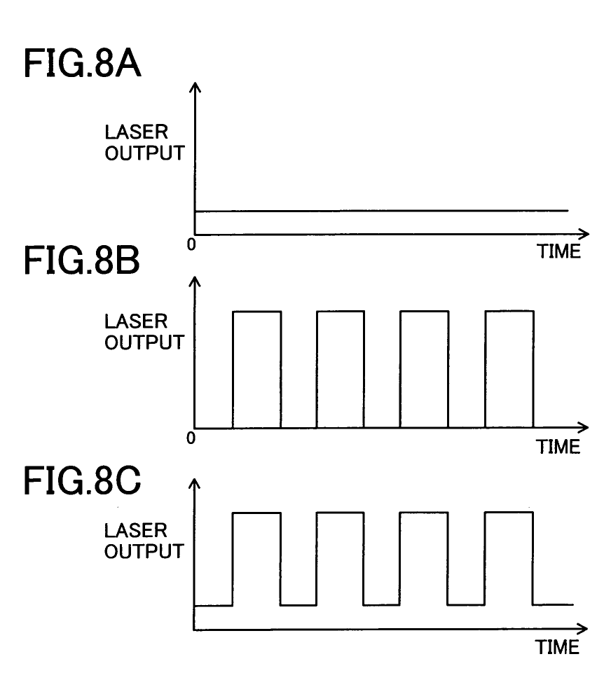

Further, as shown in FIGS. 8A-8C, it is permissible to obtain a waveform (FIG. 8C) by overlaying continuous wave (FIG. 8A), which is created by suppressing the laser power, with pulse wave (FIG. 8B), which is created by raising the laser power. Consequently, while the temperature of the irradiation face 3a (see FIG. 3 appropriately in a following description) is raised by the continuous wave and the absorption ratio rises, it is possible to introduce heat sufficiently up to the joining face 3b on the opposite side while suppressing the heat input by the pulse wave. That is, the area of the heating spot 3q created on the joining face 3b increases and as a consequence, the pulse interval can be expanded thereby suppressing the heat input. For the irradiation of the pulse laser, the feed rate of the SPCC steel sheet 3 and the aluminum alloy sheet 4 is permitted to be controlled to a constant rate or it is permitted to be intermittent synchronous with pulse.

According to this embodiment, the heat input is suppressed by adopting the pulse laser as the laser beam B from the laser 11 for heating the SPCC steel sheet 3, so that heat diffusion is carried out effectively in the aluminum alloy sheet 4 which receives heat from the SPCC steel sheet 3. If the aluminum alloy sheet 4 is cooled directly with the cooling unit 23 as described above, the temperature drop on the joining interface is performed by the effects of the both quickly. Therefore, when reducing the temperature of the joining interface, the cooling and pulse irradiation are factors for raising the cooling speed and according to this embodiment, by employing both of them, the quick temperature drop on the joining interface is achieved.

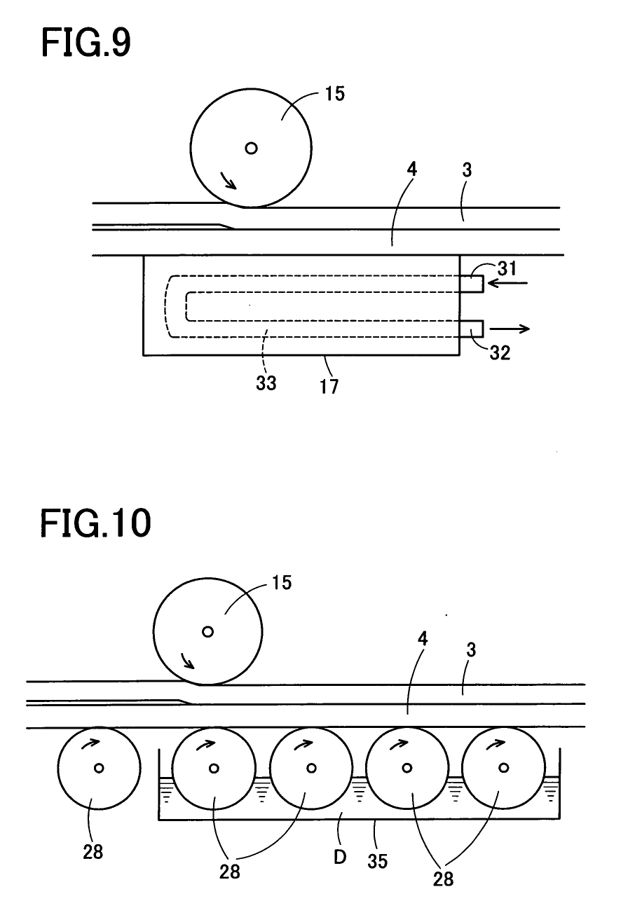

Next, a specific example of the cooling unit 23 shown in FIG. 5 will be described with reference to the drawing. The cooling is executed to the aluminum alloy sheet 4 as shown in FIG. 5. This reason is that aluminum has a higher heat conductivity than steel. FIGS. 9-11 are diagrams showing the structure for cooling the joining interface. FIG. 9 shows an example in which the SPCC steep sheet 3 and the aluminum alloy sheet 4 are disposed on the table 17 as shown in FIG. 1, in which the table 17 is used as a heat sink. The table 17 is manufactured of steel having a higher heat conductivity than aluminum and an input port 31 and an output port 32 are formed therein and a passage 33 is formed between the ports 31 and 32 so that refrigerant passes through the interior of the table 17. Consequently, the aluminum alloy sheet 4 is cooled in a wide range by the table 17 and thus, heat entering into the aluminum alloy sheet 4 when the SPCC steel sheet 3 is pressed diffuses rapidly and the temperature drop on the joining interface is carried out quickly.

Next, the equipmentes shown in FIGS. 5, 9 are so constructed that the refrigerant is controlled by the cooling unit so as to adjust the cooling capacity. In the equipment shown in FIG. 10, a plurality of the supporting rollers 28, 28, . . . are arranged in the direction of the tangent line and those supporting rollers 28, 28, . . . are immersed in a container 35 containing the refrigerant. The supporting rollers 28, 28, . . . are made of copper having a high heat conductivity and cooled by refrigerant D such as cold water so as to deprive the aluminum alloy sheet 4 of heat. Therefore, because the aluminum alloy sheet 4 is cooled by the supporting rollers 28, 28, . . . in this way, heat entering in when the SPCC steel sheet 3 is pressed diffuses rapidly so that the temperature drop on the joining interface is carried out quickly.

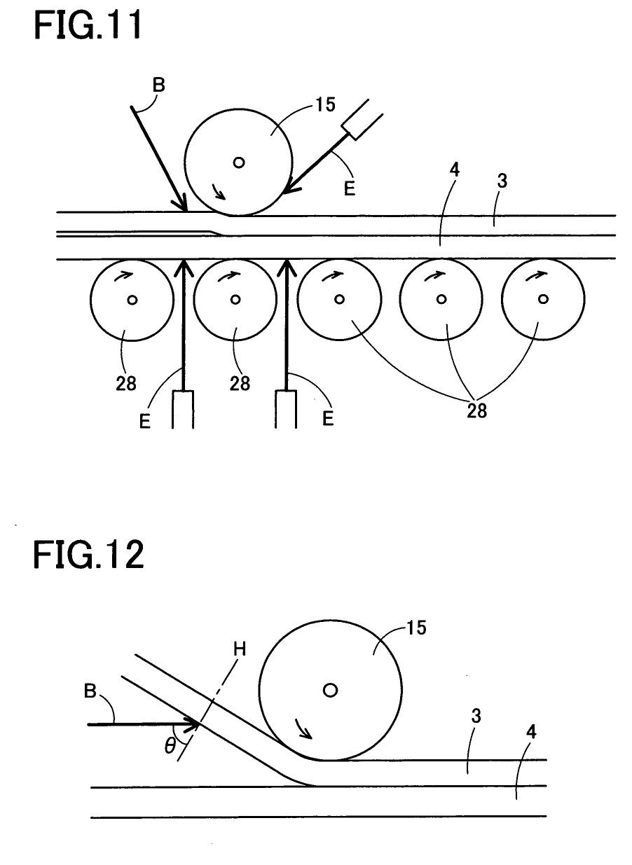

Further, FIG. 11 shows a case where the cooling is performed on the side of the SPCC steel sheet 3 as well as the side of the aluminum alloy sheet 4. Thus, it is so constructed that air or liquid nitrogen is blown against the irradiation face 3a of the SPCC steel sheet 3 from the cooling unit 23 shown in FIG. 5. At this time, refrigerant E is blown to a position which the pressure welding roller 15 applies pressure to the SPCC steel sheet 3 from an opposite side to the irradiation of the laser beam B. The pressure welding roller 15 cooled by the refrigerant E is made of copper like the supporting rollers 28, 28 . . . disposed below. In the SPCC steel sheet 3 heated by the laser irradiation, the joining face is heated to eutectoid temperature (about 1170° C.) as described above and the is joined with the aluminum alloy sheet 4 by pressure welding. After that, because the SPCC steel sheet 3 and the aluminum alloy sheet 4 are cooled by refrigerant, heat diffusion is generated in each of them. Therefore, the cooling treatment is carried out positively on the SPCC steel sheet 3 and consequently, the temperature drop is carried out further quickly in the joining interface in which the intermetallic compound is generated.

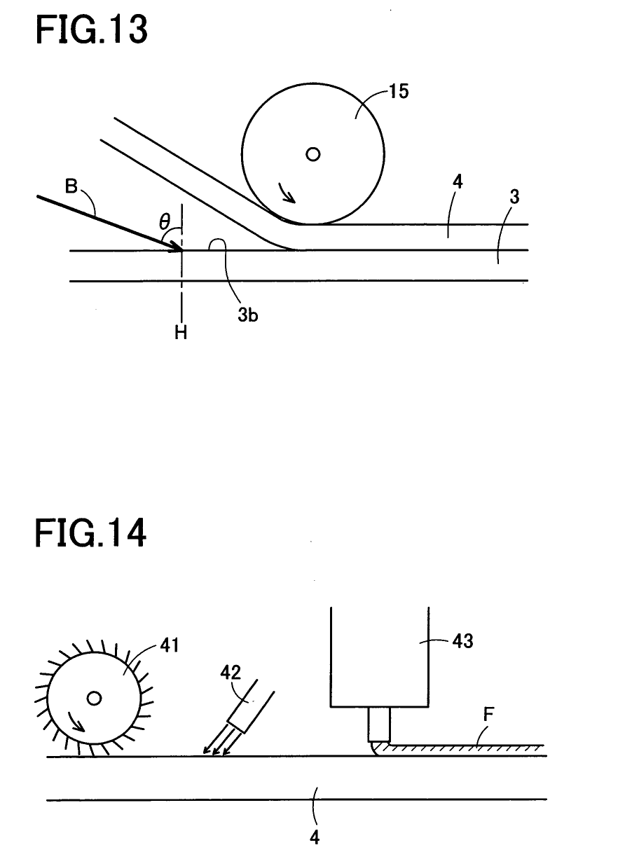

Up to now, an example in which the laser beam B is irradiated to the SPCC steel sheet 3 from the side of the non-contact face has been described. However, in the laser roll pressure welding, although the joining face needs to be heated up to the eutectoid temperature, the laser beam B is irradiated to the opposite face (irradiation face 3a) and thus, excessive heat is inputted. Next, an example in which heating is carried out effectively by irradiating the laser beam B directly to the joining face 3b will be described. FIGS. 12, 13 are diagrams showing the irradiation method to the joining face 3b in the laser roll joining equipment. When the laser beam B is irradiated to the joining face 3b, because the joining faces oppose each other, it is necessary to secure a wide interval by warping at least one metal sheet as shown in the Figure.

Because the reflected laser beam is projected to the aluminum alloy sheet 4, the laser beam B is irradiated by using a fact that the Brewster angles of the steel sheet and aluminum are different. The Brewster angle of iron Fe is 75.2 degrees and the Brewster angle of aluminum Al is 60.2 degrees. Therefore, the laser beam B is set to be irradiated to the SPCC steel sheet 3 at an incident angle of about 75 degrees. That is, the Brewster angle refers to an incident angle, which is an angle θ with respect to the normal H of the SPCC steel sheet 3 at the irradiation point as shown in the Figure. FIG. 12 shows a state in which like the above-mentioned example, the SPCC steel sheet 3 is disposed above and that SPCC steel sheet 3 is fed to the pressure welding roller 15 in conditions that the joining face 3b is warped. Conversely, FIG. 13 shows a state in which the aluminum alloy sheet 4 is disposed above and that aluminum alloy sheet 4 is fed to the pressure welding roller 15 in conditions that the aluminum alloy sheet 4 is warped.

By warping the SPCC steel sheet 3 or the aluminum alloy sheet 4 (both the sheets may be warped together), the laser beam B can be irradiated to the joining face 3b of the SPCC steel sheet 3. In the example shown in FIG. 12, the laser beam B is irradiated to the upward warped SPCC steel sheet 3. The laser beam B to impinge substantially in the horizontal direction may be irradiated directly to the SPCC steel sheet 3 from the laser 11 shown in FIG. 1 or may be irradiated indirectly using a reflection mirror 12 or the like if the direct irradiation is difficult. However, in any case, the laser beam B is irradiated to the joining face of the SPCC steel sheet 3 at the Brewster angle θ. On the other hand, in the case of FIG. 13 in which the disposition is reversed, by warping the aluminum alloy sheet 4 located above, the SPCC steel sheet 3 located below can be irradiated with the laser beam B. Then, the laser beam B is projected to the joining face 3b of the plane SPCC steel sheet 3 at the Brewster angle θ.

Referring to FIG. 12, after the warped SPCC steel sheet 3 is heated by laser irradiation, it is pressurized by the pressure welding roller 15 and pressed against the aluminum alloy sheet 4 located below. On the other hand, in FIG. 13, the aluminum sheet 4 located above after fed in the warped condition is pressed against the SPCC steel sheet 3 heated by the laser irradiation by the pressure welding roller 15. Because in any case, the joining face 3b of the SPCC steel sheet 3 has reached the eutectoid temperature (about 1170° C. in case of Fe—Al series), the pressed aluminum alloy sheet 4 is heated quickly and the temperature exceeds 650° C., which is a melting point of aluminum so that only the surface is melted. Because the melted aluminum alloy sheet 32 turns the surface of the SPCC steel sheet 3 into wetty condition, iron molecules of the SPCC steel sheet 3 diffuse in the wetty joining face 3b of the SPCC steel sheet 3, so that intermetallic compound is generated in the joining interface.

When in case of irradiating the laser beam B to the joining face 3b of the SPCC steel sheet 3 in this way, the laser beam is irradiated to the SPCC steel sheet 3 at the Brewster angle θ as shown in the Figure so as to heat the joining face 3b to the eutectoid temperature (about 1170° C.), reflection is suppressed and most of energy is absorbed by the SPCC steel sheet 3 because the incident angle is substantially the Brewster angle θ, so that the heating can be carried out effectively. Therefore, the heating for joining the SPCC steel sheet 3 and the aluminum alloy sheet 4 together can be carried out with an output in which energy consumption is suppressed.

Because the joining face 3b of the SPCC steel sheet 3 is heated directly, the necessity of heating the SPCC steel sheet 3 is eliminated, different from a case where the joining face 3b on the opposite side is heated up to the eutectoid temperature by irradiating from the irradiation face 3a like the example shown previously. When the laser beam B is pulse irradiated, the range of the irradiation spot 3p shown in FIG. 3 turns to the heating spot 3q as it is and therefore, the purpose is attained by setting the heating spots continuous. For the reason, overlapping of the irradiation spots can be decreased thereby decreasing the amount of irradiation to lead to large reduction of the amount of heat input. Therefore, by suppressing heating of the SPCC steel sheet 3, heat in the joining interface diffuses in the interior of the aluminum alloy sheet 4 immediately after the joining and cooling is performed. If it is cooled using the refrigerant like the example described previously, a further higher cooling effect can be obtained and the temperature drop can be carried out in the joining interface in which the intermetallic compound is generated, immediately.

Next, the laser roll joining equipment 1 of this embodiment is preferred to be provided with an oxidation preventing means which removes contamination by washing the joining surfaces of both the sheet members before joining with a wire brush and blowing air, and after that, coating with aluminum plating flux in order to protect the aluminum surface from oxide film. FIG. 14 is a diagram showing the oxidation preventing means of the laser roll joining apparatus 1, which is provided with a brushing roll 41, an air blow 42 and a dispenser 43 for coating with flux F for an aluminum alloy sheet 4 to be fed.

Therefore, the aluminum alloy sheet 4 to be joined with the SPCC steel sheet 3 heated as described above by pressure welding undergoes washing of the joining surface by means of the brushing roll 41 before that pressure welding and after air is blown thereto by air blowing, flux F is applied preliminarily along the joining line produced by a joining operation carried out subsequently. As for the amount of application of the flux F, a thickness of 2μ is appropriate. Then, this prevents oxide from being generated in the joining portion between the SPCC steel sheet 3 and the aluminum alloy sheet 4, thereby helping a secure joining.

To prevent the SPCC steel sheet 3 and the aluminum alloy sheet 4 from being oxidized at high temperatures, blowing inactive gas to both the sheets 3, 4 as well as coating with the flux F is effective. Further, the coating with the flux F may be carried out by spraying or screen printing as well as by using the dispenser 43.

As described in detail above, according to the laser roll joining process and the laser roll joining equipment for different type metals of this embodiment, by cooling the metal sheets positively, the temperature of the joining interface drops quickly because the internal diffusion of heat occurs effectively. Consequently, the temperature in which brittle compound is generated can be passed in an extremely short time and the amount of generation of ductile intermetallic compound is increased thereby making it possible to improve the joining break resistance of a joint.

Additionally, by irradiating the laser beam B in the form of pulses or irradiating it directly to the joining surface, the cooling effect is intensified while the amount of heat input to the metal sheet is suppressed and as a consequence, the temperature in which brittle compound is generated can be passed in an extremely short time. Thus, the amount of generation of ductile intermetallic compound is increased thereby making it possible to improve the joining break resistance of the joint.

In the meantime, the laser roll joining process for different type metal sheets of the present invention is not restricted to the above-described embodiments, but can be applied to various applications.

For example, although according to this embodiment, the SPCC steel sheet and the aluminum alloy sheet are joined together, this can be applied to combinations of other dissimilar metals, such as titan/steel, aluminum/copper, steel/iron, steel/composite material.

### INDUSTRIAL APPLICABILITY

As evident from the above description, according to the present invention, the laser roll joining equipment is provided with a cooling means so as to cool the second metal sheet from the side of the non-contact face at a position in which the first metal sheet and the second metal sheet are pressurized with the pressure welding roller. As a result, the laser roll joining process and laser roll joining equipment for dissimilar metals capable of improving the joining strength by increasing the amount of generation of ductile intermetallic compound can be provided.

According to the present invention, the laser irradiating means of the laser roll joining equipment irradiates with laser beam to the joining face of the first metal sheet after the first metal sheet and the second metal sheet are pressurized from a state in which their joining faces are widely separate, by the pressure welding roller and fed in conditions that they overlap. As a consequence, it is possible to provide the laser roll joining process for dissimilar metals and laser roll joining equipment, in which the cooling effect is intensified by suppressing the amount of input heat to the metal sheet, so that the amount of generation of ductile intermetallic compound is increased to improve the joining strength of the joint.

Further, according to the present invention, the laser roll joining equipment has a control means and by controlling the drive by that control means, the laser irradiating means irradiates the irradiation spots of laser beam, outputted in the form of pulses, such that they overlap in the direction of the joining line on the non-contact face of the first metal sheet. As a consequence, it is possible to provide the laser roll joining process for dissimilar metals and laser roll joining equipment, in which the cooling effect is intensified by suppressing the amount of input heat to the metal sheet, so that the amount of generation of ductile intermetallic compound is increased to improve the joining strength of the joint.

Further, the effect and future perspective of the present invention are summarized as follows.

(1) Joining in joint of different metals, which is difficult conventionally because brittle intermetallic compound is generated, is enabled and the reliability of that joint can be intensified. Example: Fe—Al series, Co—Al series, Cr—Al series and the like

(2) By enabling joining of light metal such as aluminum alloy with high strength metal or joining with more durable metal by processing, light weight panel and light weight durable panel (maintenance free) can be manufactured.

(3) Light weight fire resistant panel can be manufactured.

(4) A manufacturing process for following light weight structures and parts is provided:
a. Light-weight hybrid structured body (sandwich panel 1);
b. Light-weight hybrid structured body (sandwich panel 2);
c. Tailored blank material (aluminum-steel butt joint);
d. T-joint (fillet welded joint) member.

(5) It contributes largely to reduced weight of transportation units.

(6) It can be expected as energy saving, low-distortion joining technology.

(7) If semi-melt joining process is applied, it can be expected as a highly reliable metallic joining joint.

1. A laser roll joining process for dissimilar metals for joining together a first metal sheet and a second metal sheet of different materials held in non-contact state by after only the first metal sheet is heated by laser irradiation, pressing a heated portion of the first metal sheet against the second metal sheet with a pressure welding roller so that they are brought into a firm contact with each other and subjected to plastic deformation, wherein
a joining portion between the first metal sheet and the second metal sheet is cooled.

2. The laser roll joining process for dissimilar metals according to claim 1 wherein the second metal sheet is cooled from the side of non-contact face at a position in which the first metal sheet and the second metal sheet are pressed against each other with the pressure welding roller.

3. The laser roll joining process for dissimilar metals according to claim 2, wherein the pressure welding roller and the first metal sheet are cooled.

4. The laser roll joining process for dissimilar metals according to claim 1, wherein the pressure welding roller and the first metal sheet are cooled.

5. The laser roll joining process for dissimilar metals according to claim 1, wherein to prevent both the metal sheets to be joined together from being oxidized under high temperatures, inactive gas is blown against the both sheets and flux is applied to the material side having strong oxide film such as aluminum.

6. The laser roll joining process for dissimilar metals according to claim 5 wherein the amount of application of the flux is 2 μm or less.

7. The laser roll joining process for dissimilar metals according to claim 1, wherein the joining is carried out with steel sheet as the first metal sheet and aluminum sheet or aluminum alloy sheet as the second metal sheet.

8. A laser roll joining process for dissimilar metals joining together a first metal sheet and a second metal sheet of different materials held in non-contact state by after only the first metal sheet is heated by laser irradiation, pressing a heated portion of the first metal sheet against the second metal sheet with a pressure welding roller so that they are brought into a firm contact with each other and subjected to plastic deformation, wherein
said first metal sheet and the second metal sheet in conditions that the joining faces are widely separated are fed so that they overlap each other at a pressure welding roller position while laser is irradiated to the joining face of the first metal sheet, and after that the first metal sheet is pressed against the second metal sheet by means of the pressure welding roller.

9. The laser roll joining process for dissimilar metals according to claim 8 wherein laser beam is irradiated to the first metal sheet at substantially the Brewster angle.

10. The laser roll joining process for dissimilar metals according to claim 8, wherein to prevent both the metal sheets to be joined together from being oxidized under high temperatures, inactive gas is blown against the both sheets and flux is applied to the material side having strong oxide film such as aluminum.

11. The laser roll joining process for dissimilar metals according to claim 10, wherein the amount of application of the flux is 2 μm or less.

12. The laser roll joining process for dissimilar metals according to claim 8, wherein the joining is carried out with steel sheet as the first metal sheet and aluminum sheet or aluminum alloy sheet as the second metal sheet.

13. A laser roll joining process for dissimilar metals for joining together a first metal sheet and a second metal sheet of different materials held in non-contact state by after the first metal sheet is heated by irradiating pulse-like laser beam from the side of the non-contact face, pressing a heated portion of the first metal sheet against the second metal sheet with a pressure welding roller so that they are brought into a firm contact with each other and subjected to plastic deformation, wherein
irradiation spots of laser beam outputted in the pulse-like form are irradiated to the non-contact face of the first metal sheet such that they overlap in the direction of the tangent line.

14. The laser roll joining process for different metal according to claim 13, wherein the overlapping of the irradiation spots is determined so that the heating spots generated on the side of the joining face of the first metal sheet by the laser irradiation are continuous, before the pulse-like laser beam is irradiated.

15. The laser roll joining process for dissimilar metals according to claim 14, wherein the pulse irradiation and the feed rates of the first and second metal sheets are synchronized so that the heating spots are continuous.

16. The laser roll joining process for dissimilar metals according to claim 13, wherein the pulse irradiation and the feed rates of the first and second metal sheets are synchronized so that the heating spots are continuous.

17. The laser roll joining process for dissimilar metals according to claim 13, wherein to prevent both the metal sheets to be joined together from being oxidized under high temperatures, inactive gas is blown against the both sheets and flux is applied to the material side having strong oxide film such as aluminum.

18. The laser roll joining process for dissimilar metals according to claim 17, wherein the amount of application of the flux is 2 μm or less.

19. The laser roll joining process for dissimilar metals according to claim 13, wherein the joining is carried out with steel sheet as the first metal sheet and aluminum sheet or aluminum alloy sheet as the second metal sheet.

20. A laser roll joining equipment for dissimilar metals for joining together a first metal sheet and a second metal sheet of different materials held in non-contact state, by pressing the heated first metal sheet against the second metal sheet so as to induce plastic deformation, comprising: a laser irradiating means for irradiating with laser only the first metal sheet to heat it; and a roller pressing means for pressing the heated portion of the first metal sheet heated by the laser irradiation by the laser irradiating means against the second metal sheet with a pressure welding roller so that they are brought into a firm contact with each other, the laser roll joining equipment further comprising a cooling means for cooling a joining portion between the first metal sheet and the second metal sheet.

21. The laser roll joining equipment for dissimilar metals according to claim 20, wherein the cooling means is provided to cool the second metal sheet from the side of the non-contact face at a position in which the first metal sheet and the second metal sheet are pressurized by the pressure welding roller.

22. The laser roll joining equipment for dissimilar metals according to claim 21, wherein the cooling means is provided to cool the pressure welding roller and the first metal sheet.

23. The laser roll joining equipment for dissimilar metals according to claim 20, wherein the cooling means is provided to cool the pressure welding roller and the first metal sheet.

24. The laser roll joining equipment for dissimilar metals according to claim 20 further comprising an oxidation preventing means for blowing inactive gas to the joining portion of both the sheets or coating the side of the material having strong oxide film like aluminum with flux in order to prevent both the metal sheets to be joined together from being oxidized under high temperatures.

25. The laser roll joining equipment for dissimilar metals according to claim 24, wherein the oxidation preventing means coats with flux by spraying, screen printing or with dispenser.

26. The laser roll joining equipment for dissimilar metals according to claim 20, wherein the joining is carried out with steel sheet as the first metal sheet and aluminum sheet or aluminum alloy sheet as the second metal sheet.

27. A laser roll joining equipment for dissimilar metals for joining together a first metal sheet and a second metal sheet of different materials held in non-contact state by pressing the heated first metal sheet against the second metal sheet so as to induce plastic deformation, comprising: a laser irradiating means for irradiating with laser only the first metal sheet to heat it; and a roller pressing means for pressing the heated portion of the first metal sheet heated by the laser irradiation by the laser irradiating means against the second metal sheet with a pressure welding roller so that they are brought into a firm contact with each other, wherein
said first metal sheet and the second metal sheet are pressurized against each other from a state in which the joining faces are widely separate and fed in conditions that they overlap, and the laser irradiating means is provided to irradiate the joining face of the first metal sheet with laser.

28. The laser roll joining equipment for dissimilar metals according to claim 27, wherein the laser irradiating means is so provided that the incident angle of laser beam to the first metal sheet is substantially the Brewster angle.

29. The laser roll joining equipment for dissimilar metals according to claim 27 further comprising an oxidation preventing means for blowing inactive gas to the joining portion of both the sheets or coating the side of the material having strong oxide film like aluminum with flux in order to prevent both the metal sheets to be joined together from being oxidized under high temperatures.

30. The laser roll joining equipment for dissimilar metals according to claim 29, wherein the oxidation preventing means coats with flux by spraying, screen printing or with dispenser.

31. The laser roll joining equipment for dissimilar metals according to claim 27, wherein the joining is carried out with steel sheet as the first metal sheet and aluminum sheet or aluminum alloy sheet as the second metal sheet.

32. A laser roll joining equipment for dissimilar metals for joining together a first metal sheet and a second metal sheet by pressing the heated first metal sheet against the second metal sheet of different materials in non-contact state so as to induce plastic deformation, comprising: a laser irradiating means for irradiating the first metal sheet with pulse-like laser beam from the side of the non-contact face to heat it; and a roller pressing means for pressing the heated portion of the first metal sheet heated by the laser irradiation by the laser irradiating means against the second metal sheet with a pressure welding roller, wherein
said laser irradiating means is connected to a control means and irradiation spots of laser beam outputted in the form of pulses are irradiated by drive control by the control means such that the irradiation spots overlap in the direction of a joining line on the non-contact face of the first metal sheet.

33. The laser roll joining equipment for dissimilar metals according to claim 32, wherein the control means is provided to control the drive of the laser irradiating means so that the heating spots generated on the side of the joining face of the first metal sheet are continuous by overlapping the irradiation spots.

34. The laser roll joining equipment for dissimilar metals according to claim 33, wherein the control means synchronizes the pulse irradiation with the feed rates of the first and second metal sheets so that the heating spots are continuous.

35. The laser roll joining equipment for dissimilar metals according to claim 32, wherein the control means synchronizes the pulse irradiation with the feed rates of the first and second metal sheets so that the heating spots are continuous.

36. The laser roll joining equipment for dissimilar metals according to claim 32 further comprising an oxidation preventing means for blowing inactive gas to the joining portion of both the sheets or coating the side of the material having strong oxide film like aluminum with flux in order to prevent both the metal sheets to be joined together from being oxidized under high temperatures.

37. The laser roll joining equipment for dissimilar metals according to claim 36, wherein the oxidation preventing means coats with flux by spraying, screen printing or with dispenser.

38. The laser roll joining equipment for dissimilar metals according to claim 32, wherein the joining is carried out with steel sheet as the first metal sheet and aluminum sheet or aluminum alloy sheet as the second metal sheet.
